(19) United States
(12) Patent Application Publication
(10) Pub. No.: US 2013/0141541 A1
(43) Pub. Date: Jun. 6, 2013

(54) COMPACT CAMERA ACTUATOR AND COMPACT STEREO-SCOPIC IMAGE PHOTOGRAPHING DEVICE

(71) Applicants: He Won Jung, Ansan-si (KR); Jae Kyu Shim, Ansan-si (KR); Ki Hyun Jung, Ansan-si (KR); Jong Sik Seo, Ansan-si (KR); Yo Sub Kim, Ansan-si (KR)

(72) Inventors: He Won Jung, Ansan-si (KR); Jae Kyu Shim, Ansan-si (KR); Ki Hyun Jung, Ansan-si (KR); Jong Sik Seo, Ansan-si (KR); Yo Sub Kim, Ansan-si (KR)

(73) Assignee: HYSONIC. CO., LTD., Ansan-si (KR)

(21) Appl. No.: 13/805,078

(22) PCT Filed: Jun. 13, 2011
(86) PCT No.: PCT/KR2011/004317

§ 371 Date: Dec. 18, 2012

(30) Foreign Application Priority Data
Jun. 11, 2010 (KR) 10-2010-0055255
Jun. 11, 2010 (KR) 10-2010-0055256
Jun. 29, 2010 (KR) 10-2010-0062295

(51) Int. Cl. H04N 5/225; H04N 13/00

(52) U.S. Cl. CPC H04N 5/225; H04N 13/00
USPC 348/46

(57) ABSTRACT

The purpose of the present invention is to provide a compact three-dimensional image photographing device capable of adjusting the first angle of view on an object being picked up on the image sensor by adjusting the space between two lenses by moving the two lenses horizontally, left and right. The compact three-dimensional image photographing device of the present invention comprises a case; a first holder and a second holder mounted spaced apart from each other on the left and right sides in the case so that the holders can move in the left and right directions, each of the holders having a compact camera actuator therein; a guide shaft, passing through the first and second holders and thus mounted on the case, for guiding the left and right movements of the first holder and the second holder; and left and right driving portions, mounted respectively on the first holder and the second holder, for moving the first holder and the second holder left and right.

### TECHNICAL FIELD

The present invention relates to a compact stereoscopic image photographing device, and particularly to a compact stereoscopic image photographing device which can adjust a vergence angle of two lenses with respect to an object in order to take a stereoscopic image.

### BACKGROUND ART

The application field of mobile communication terminals that typically transmit audio information has been rapidly increasing with recent development of high speed data transmission technology. As a result, it has been a general tendency to transmit still images or moving images using the mobile communication terminals, for example, in on-demand mobile broadcasting service or multi-messaging service and so on.

However, users of the mobile communication terminal are not content with this, and they further require a new terminal which can display a stereoscopic image. In order to satisfy the users' requirement, there have been proposed a new mobile terminal which can display a 3D image, and a new 3D image photographing apparatus which takes the 3D image.

Meanwhile, an electro-active polymer called as artificial muscle is formed of a polymer-metal composite containing various metallic materials and thus having various properties.

The polymer-metal composite has physical characteristics such as light weight and flexibility and also has some advantages such as rapid reaction time, continuous driving, calculation of comparatively large displacement and the ability to be manufactured into a micro-structure. Accordingly, the polymer-metal composite has been applied to a compact camera actuator.

The polymer-metal composite is detailedly disclosed in U.S. Pat. No. 7,169,822 and Japanese Patent Application Laid-Open No. 2006-172635.

Meanwhile, a camera actuator in which lenses are adjusted by using the polymer-metal composite has been developed recently.

Korean Patent Application Laid-Open No. 10-2010-0036548 filed by the applicant describes a camera actuator using a polymer-metal composite.

However, in the conventional camera actuator using a polymer-metal composite, since lenses are supported by springs, lots of power is needed to drive the lenses mutually, and thus the structure is further complicated by using a large amount of the polymer.

### DISCLOSURE

### Technical Problem

An object of the present invention is to provide a compact stereoscopic image photographing device which can adjust a vergence angle on an object being picked up on an image sensor by adjusting a space between two lenses by moving the two lenses horizontally, left and right.

Further, another object of the present invention is to a compact stereoscopic image photographing device which can provide returning force, without using a spring, to a lens holder using an attraction between a magnetic body and a magnet, thereby simplifying structure thereof.

### Technical Solution

To achieve the object of the present invention, the present invention can provide a compact stereoscopic image photographing device comprising a case; a first holder and a second holder which are mounted to be spaced apart from each other on the left and right sides in the case so that the holders can be moved left and right, each of the holders having a compact camera actuator therein; a guide shaft which passes through the first and second holders and which is mounted on the case so as to guide left and right movements of the first holder and the second holder; and left and right driving parts which are mounted respectively on the first holder and the second holder so as to move the first holder and the second holder left and right.

Preferably, the guide shaft comprises a firs guide shaft and a second guide shaft which are parallelly disposed to be spaced apart from each other, and

one end of the first holder and one end of the second holder are formed with a first insertion hole which is opened left and right, and the other end of the first holder and the other end of the second holder are formed with a second insertion hole which is opened left and right in an opposite direction of the first insertion hole.

Preferably, the left and right driving parts comprise a first driving part which is disposed between an outer side surface of the first holder and an inner side surface of the case; and a second driving part which is disposed between an outer side surface of the second holder and an inner side surface of the case so as to be horizontally spaced apart from the first driving part.

Preferably, the first driving part comprises a first coil member which is installed at one of a side surface of the first holder and a side surface of the case; and a first magnet which is installed at one of a side surface of the first holder and a side surface of the case so as to be oppositely spaced apart from the first coil member, and the second driving part comprises a second coil member which is installed at one of a side surface of the second holder and a side surface of the case; and a second magnet which is installed at one of a side surface of the second holder and a side surface of the case so as to be oppositely spaced apart from the second coil member.

Preferably, the first driving part further comprises a first magnetic member installed at one of the side surface of the first holder and the side surface of the case, in which the first coil member is installed, and the second driving part further comprises a second magnetic member installed at one of the side surface of the first holder and the side surface of the case, in which the second coil member is installed, and the first magnetic member and the second magnetic member are oppositely spaced apart from the first magnet and the second magnet, respectively, so as to attract the first holder and the second holder in left and right directions by influence of gravity with the first magnet and the second magnet when the first holder and the second holder are moved.

Preferably, the first holder and the second holder comprise a body part which covers one end and the other end of the compact camera actuator; a first supporting part which connects an upper portion of one end of the body part and an upper portion of the other end thereof so as to cover one side of an upper surface of the compact camera actuator and through which the guide shaft is passed; a second supporting part and a third supporting part which are respectively protruded in opposite directions to each other at upper portions of the one end and the other end of the body part so as to be contacted with the other end of the upper surface of the compact camera actuator and which are spaced apart in a left or right direction of the first supporting part and also through which the guide shaft is passed; and a fourth supporting part which is protruded from a lower portion of the body part to a lower portion of the compact camera actuator so as to support the lower portion of the compact camera actuator.

Further, the present invention provides a compact camera actuator comprising a housing; a lens holder which is movably installed in the housing and in which a lens is provided; a driving means which is installed at the housing so as to move the lens holder upward when power is applied; a magnetic body which is fixed to one of the lens holder and the housing; and a magnet which is fixed to the other of the lens holder and the housing, wherein the magnet body and the magnet are spaced apart from each other, and downwardly attracting force is applied to the lens holder by influence of gravity between the magnetic body and the magnet.

Preferably, a first supporting plate and a second supporting plate are protruded from left and right sides of the lens holder, and the driving means comprises a first polymer member of which one end is fixed to the housing and the other end is contacted with a lower portion of the first supporting plate so as to support the first supporting plate; and a second polymer member of which one end is fixed to the housing and the other end is contacted with a lower portion of the second supporting plate so as to support the second supporting plate, and the other end of the first polymer member and the other end of the second polymer member are bent upward so as to lift up the lens holder when power is applied to the first polymer member and the second polymer member.

Preferably, one end of the first polymer member and one end of the second polymer member are respectively formed with a first holding part and a second holding part which are protruded toward the lens holder so as to cover an outer circumferential surface of the lens holder.

Preferably, the magnetic body is installed at the lens holder, and the magnet is installed at the housing, and the magnetic body comprises a first iron piece and a second iron piece which are disposed at side surfaces of the lens holder so as to be spaced apart in left and right directions; and a third iron piece which is disposed between the first iron piece and the second iron piece so as to be installed at a side surface of the lens holder, and the magnet comprises a first magnet which is fixed to a side surface of the housing so as to be oppositely spaced apart from the first iron piece; and a second magnet which is fixed to a side surface of the housing so as to be oppositely spaced apart from the second iron piece, and the first magnet and the second magnet are symmetric with respect to the third iron piece.

Preferably, the lens holder is lifted up by the driving means, a longitudinal center portion of the first iron piece is disposed to be higher than a longitudinal center portion of the first magnet, and a longitudinal center portion of the second iron piece is disposed to be higher than a longitudinal center portion of the second magnet.

Preferably, the compact camera actuator further comprises a guide means which is disposed between the lens holder and the housing so as to guide the lens holder upward.

Preferably, the guide means comprises a guide plate which is movably disposed between a side surface of the lens holder and a side surface of the housing; and a guide ball which is rotatably inserted into the guide plate and contacted with the side surface of the lens holder and the side surface of the housing so as to be rotated upward and downward when the lens holder is moved up and down.

Preferably, the side surface of the housing is formed with a first guide groove which is opened upward and downward so as to guide up and down movement of the guide ball, and the side surface of the lens holder is formed with a second guide groove which is opened upward and downward so as to guide up and down movement of the guide ball.

Further, the present invention provides a compact stereoscopic image photographing device, comprising a base having a first image sensor and a second image sensor which is spaced apart from each other; and a first actuator having a first lens which picks up an object on the first image sensor; a second actuator having a second lens which picks up the object on the second image sensor, wherein the first actuator and the second actuator comprise a holder which is disposed at an upper side of the first image sensor or the second image sensor so as to be coupled to the base; a cover which covers the holder; a lens unit which is installed in the holder so as to be moved up/down and left/right and also has one of the first lens or the second lens therein; a first driving part which is disposed between one side portion of the holder and one side portion of the lens unit so as to move the lens unit up and down and thus to achieve automatic focusing of the object picked up on the first image sensor and the second image sensor through the first lens and the second lens; a second driving part which is disposed between the other side portion of the holder and the other side portion of the lens unit so as to move the lens unit left and right, and a vergence angle with respect to the object picked up on the first image sensor and the second image sensor through the first lens and the second lens is adjusted by controlling a space between the first lens and the second lens using the second driving part.

Preferably, the first driving part comprises a first coil member which is installed at one of one side surface of the holder and one side surface of the lens unit; and a first magnet which is installed at the other of one side surface of the holder and one side surface of the lens unit so as to be opposed to the first coil member, and the second driving part comprises a second coil member which is installed at one of the other side surface of the holder and the other side surface of the lens unit; and a second magnet which is installed at the other of the other side surface of the holder and the other side surface of the lens unit so as to be opposed to the second coil member, and the lens unit is moved up and down by reciprocal action between a first electromagnetic field generated when power is applied to the first coil member and a first magnetic field generated from the first magnet, and the lens unit is moved left and right by reciprocal action between a second electromagnetic field generated when power is applied to the second coil member and a second magnetic field generated from the second magnet.

Preferably, the first coil member is installed at one side portion of the lens unit, and the first magnet is installed at one side of the holder so as to be opposed to the first coil member, and the second coil member is installed at the other side portion of the lens unit, and the second magnet is installed at the other side portion of the holder so as to be opposed to the second coil member, and a first protrusion is formed at the one side portion of the lens unit to be protruded toward the first magnet, and a second protrusion is formed at the other side portion of the lens unit to be protruded toward the second magnet, and the first coil member is wound around the first protrusion, and the second coil member is wound around the second protrusion, and poles of the first magnet are divided up and down, and poles of the second magnet are divided left and right.

Preferably, the compact stereoscopic image photographing device further comprises a wire spring which connects the other side portion of the lens unit and the other side portion of the holder so as to elastically support the lens unit in all directions.

Preferably, the cover is formed of a magnetic body and disposed to cover the first magnet and the second magnet so that magnetic force lines generated from N-poles of the first and second magnets are induced to S-pole of the first and second magnets through the first and second coil members.

### Advantageous Effects

According to the present invention as described above, the present invention can obtain the 3D image by adjusting the space between the first and second holders having the compact camera actuators and thus adjusting the vergence angle of an object being picked up on an image sensor.

### DESCRIPTION OF DRAWINGS

The above and other objects, features and advantages of the present invention will become apparent from the following description of preferred embodiments given in conjunction with the accompanying drawings, in which:

FIG. 1 is a perspective view of a compact stereoscopic image photographing device according to a first embodiment of the present invention.

FIG. 2 is an exploded perspective view of the compact stereoscopic image photographing device according to the first embodiment of the present invention.

FIG. 3 is a cross-sectional view taken along a line A-A of FIG. 1.

FIG. 4 is a perspective view of a compact camera actuator according to a first embodiment of the present invention.

FIG. 5 is an exploded perspective view of the compact camera actuator, when viewed in one direction, according to the first embodiment of the present invention.

FIG. 6 is an exploded perspective view of the compact camera actuator, when viewed in another direction, according to the first embodiment of the present invention.

FIG. 7 is an exploded perspective view of main parts of the compact camera actuator according to the first embodiment of the present invention.

FIG. 8 is a cross-sectional view taken along a line C-C of FIG. 4.

FIG. 9 is a view showing an operation process of the compact camera actuator according to the first embodiment of the present invention.

FIG. 10 is a view showing an operation process of the compact stereoscopic image photographing device according to the first embodiment of the present invention.

FIG. 11 is an exploded perspective view of the compact stereoscopic image photographing device according to other type of the first embodiment of the present invention.

FIG. 12 is a perspective view of the compact stereoscopic image photographing device according to a second embodiment of the present invention.

FIG. 13 is an exploded perspective view of the compact stereoscopic image photographing device according to the second embodiment of the present invention.

FIG. 14 is an exploded perspective view of main parts according to the second embodiment of the present invention.

FIGS. 15 to 17 are views showing operation processes of the compact stereoscopic image photographing device according to the second embodiment of the present invention.

### BEST MODE

Hereinafter, the embodiments of the present invention will be described in detail with reference to accompanying drawings.

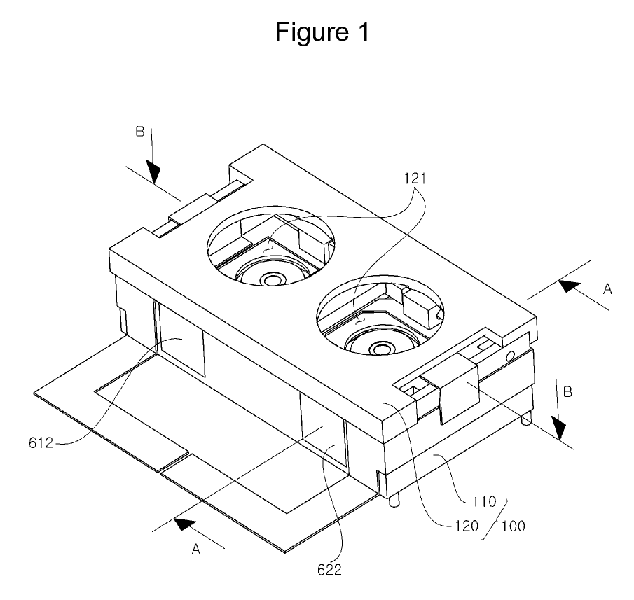

As shown in FIGS. 1 to 3 and 10, a compact stereoscopic image photographing device according to the first embodiment of the present invention includes a case 100, a first holder 200, a second holder 300, a compact camera actuator 400, a guide shaft 500 and a left and right driving part 600.

The case 100 is formed into a rectangular parallelepiped shape and comprised of a main body 110 and a cover 120.

That is, the main body 110 is formed into the rectangular parallelepiped shape of which upper and lower portions are opened and also that a connection part 111 connecting both side surfaces of the main body 110 is formed at an upper center portion thereof.

The first and second holders 200 and 300 are disposed in the main body 110 so as to be movable left and right.

The cover 120 is formed into a rectangular shape so as to be installed at an upper portion of the main body 110.

And the cover 120 is formed with an opening 121 which is opened up and down.

Two openings 121 are provided and arranged to be bilaterally symmetrical with respect to a center portion of the cover 120.

The first holder 200 and second holder 300 are disposed in the main body 110 so as to be spaced apart from each other and movable left and right, and a compact camera actuator 400 is provided in each of the first and second holders 200 and 300.

More detailedly, each of the first and second holders 200 and 300 includes a body part 210, 310, a first supporting part 220, 320, a second supporting part 230, 330, a third supporting part 240, 340 and a fourth supporting part 250, 350.

The body part 210, 310 is formed into a square shape and also formed to cover one end and the other end of the compact camera actuator 400.

In other words, each of the body part 210, 310 is disposed at one end and the other end of the compact camera actuator 400 so as to cover them.

As described later, a fixing part 260, 360 to which the left and right driving part 600 is installed is formed at an outer side surface of the body part 210, 310 so as to be protruded outside.

The fixing part 260, 360 is formed into a U-shape and arranged to be opened upward.

The first supporting part 220, 320 functions to connect an upper portion of one end of the body part 210, 310 and an upper portion of the other end thereof and thus to cover one part of an upper surface of the compact camera actuator 400.

In other words, the first supporting part 220, 320 is extended from the upper portion of one end of the body part 210, 310 toward the upper portion of the other end thereof so as to connect the body part 210, 310 and thus to be contacted with one part of the upper surface of the compact camera actuator 400.

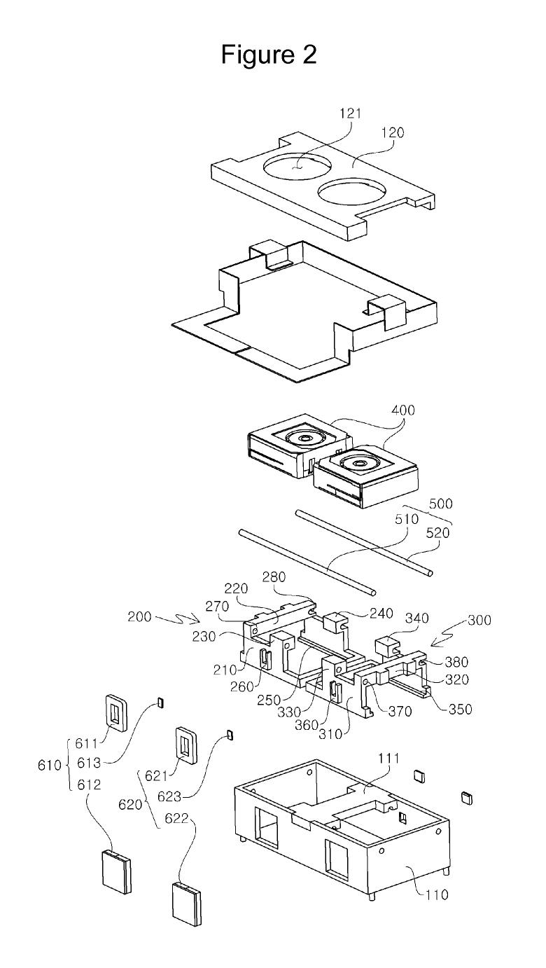

And as shown in FIG. 2, the first supporting part 220 provided at the first holder 200 is disposed at a left side of the body part 210, and the first supporting part 320 provided at the second holder 300 is disposed at a left side of the body part 310.

The second supporting part 230, 330 and third supporting part 240, 340 are respectively formed into a square shape so as to be oppositely protruded from the upper portions of one end and the other end of the body part 210, 310.

The second supporting part 230, 330 and third supporting part 240, 340 are contacted with the other part of the upper surface of the compact camera actuator 400 and also respectively disposed to be spaced apart toward a left or right side of the first supporting part 220, 320.

That is, as shown in FIG. 2, the second and third supporting parts 230 and 240 provided at the first holder 200 are disposed to be spaced apart toward the right side of the first supporting part 220, and the second and third supporting parts 330 and 340 provided at the second holder 300 are disposed to be spaced apart toward the left side of the first supporting part 320.

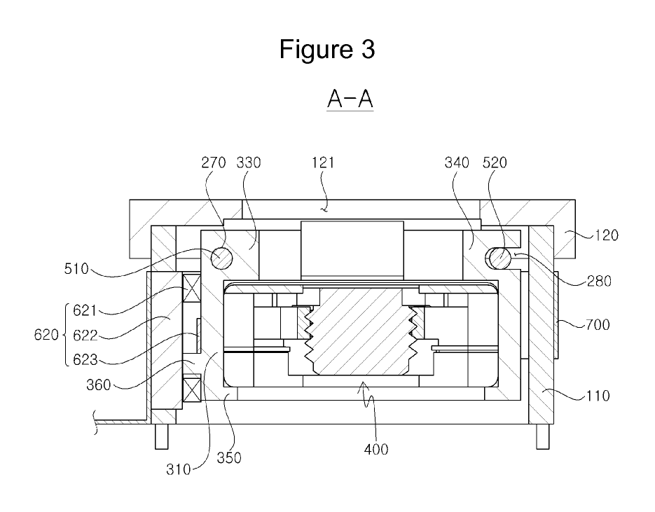

Further, as shown in FIG. 3, one end of the first supporting part 220, 320 and the second supporting part 230, 330 are formed with a first insertion hole 270, 370, and the other end of the first supporting part 220, 320 and the third supporting part 240, 340 are formed with a second insertion hole 280, 380.

The first insertion hole 270, 370 is formed into a cylindrical shape which is arranged left and right. The first insertion hole 270 formed in one end of the first supporting part 220, 320 and the first insertion hole 370 formed in the second supporting part 230, 330 are disposed coaxially.

The guide shaft 500 is inserted into the first insertion hole 270, 370.

The second insertion hole 280, 380 is formed into a long-hole shape which is arranged left and right so as to be opened in an opposite direction to the first insertion hole 270, 370.

The second insertion hole 280 formed in the other end of the first supporting part 220, 320 and the second insertion hole 380 formed in the second supporting part 230, 330 are disposed coaxially.

The guide shaft 500 is inserted into the second insertion hole 280, 380.

As described above, the first insertion hole 270, 370 is formed to be opened left and right and the second insertion hole 280, 380 is formed to be opened left and right in the opposite direction to the first insertion hole 270, 370. Therefore, even though a center of each first insertion hole 270, 370 formed in the first and second holders 200 and 300 is twisted when assembling the guide shaft 500, the guide shaft 500 is allowed to be facilely assembled by controlling positions of the first and second holders 200 and 300 through the second insertion hole 280, 380. Further, it is possible to reduce friction between the guide shaft 500 and the first and second holders 200 and 300, thereby achieving smooth operation thereof.

The fourth supporting part 250, 350 is formed at a lower side of the body part 210, 310 so as to be protruded to a lower side of the compact camera actuator 400, thereby supporting a lower portion of the compact camera actuator 400.

A distance between an upper surface of the fourth supporting part 250, 350 and the first supporting part 220, 320 and between the second supporting part 230, 330 and a lower surface of the third supporting part 240, 340 is the same as a height of the compact camera actuator 400.

As described above, since each of the first and second holders 200 and 300 is comprised of the first supporting part 220, 320 which is contacted with the upper surface of the compact camera actuator 400, the second supporting part 230, 330 and the third supporting part 240, 340 which are spaced apart toward a lateral side of the first supporting part 220, 320 so as to be contacted with the upper surface of the compact camera actuator 400, and the fourth supporting part 250, 350 which supports the lower portion of the compact camera actuator 400, it is possible to simplify the structure of the first and second holders 200 and 300 and also to reduce a weight thereof, and thus they can be readily driven with small force.

In the compact camera actuator 400, a lens 430 is installed therein to be moved up and down so as to adjust a focus of an object.

Hereinafter, the compact camera actuator 400 will be described in detail.

Meanwhile, the guide shaft 500 includes a first guide shaft 510 and a second guide shaft 520 which are parallelly arranged to be spaced apart from each other.

The first and second guide shafts 510 and 520 are respectively formed into a cylindrical shape which is formed to be elongated left and right. The first and second guide shafts 510 and 520 are installed in the case 100 so as to be passed through the first and second holders 200 and 300.

In other words, left and right ends of each of the first and second guide shafts 510 and 520 are fixed to left and right ends of the main body 110.

The first guide shaft 510 is disposed to be passed through the first insertion hole 270, 370, and the second guide shaft 520 is disposed to be passed through the second insertion hole 280, 380.

Meanwhile, the left and right driving part 600 is installed at each of the first and second holders 200 and 300 so as to move the first and second holders 200 and 300 left and right.

More detailedly, the left and right driving part 600 is comprised of a first driving part 610 and a second driving part 620.

The first driving part 610 is disposed between an outer side surface of the first holder 200 and an inner side surface of the case 100 and comprised of a first coil member 611, a first magnet 612 and a first magnetic member 613.

The first coil member 611 is installed at the outer side surface of the body part 210, 301 of the first holder 200 and wound around the fixing part 260, 360.

The first magnet 612 is installed at the inner side surface of the main body 110 of the case 100 so as to be opposed to the first coil member 611 while being spaced apart from the first coil member 611.

In the first driving part 610, force is generated by reciprocal action with the first magnet 612 when power is applied to the first coil member 611, and thus the first holder 200 is moved left and right.

If necessary, the first coil member 611 may be installed at the inner side surface of the main body 110, and the first magnet 612 may be installed at the outer side surface of the first holder 200.

The first magnetic member 613 formed into a square shape is formed of a material which can be stuck to the magnet, installed at the outer side surface of the first holder 200 in which the first coil member 611 is installed, and arranged at a center portion of the first coil member 611.

Since the first magnetic member 613 is disposed to be opposed to the first magnet 612 while being spaced apart from the first magnet 612, the first holder 200 is attracted left and right by the reciprocal action with the first magnet 612.

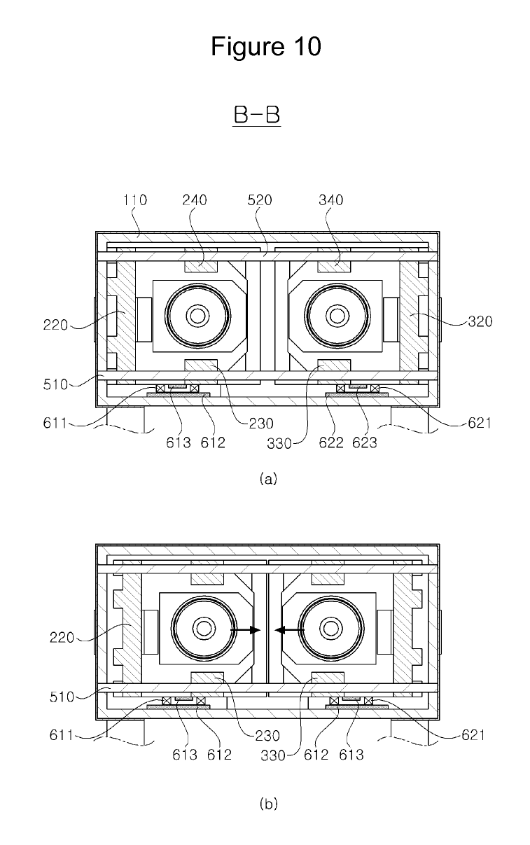

That is, as shown in FIG. 10, a center portion of the first magnetic member 613 and a center portion of the first magnet 612 are disposed concentrically before the first holder 200 is driven. And when the first holder 200 is move left and right, the first holder 200 is attracted left and right by attraction force which concentrically brings the center portion of the first magnet 612 into contact with the center portion of the first magnetic member 613.

The second driving part 620 is disposed between the outer surface of the second holder 200 and the inner surface of the case 100 so as to be horizontally spaced apart from the first driving part 610.

In other words, as shown in FIG. 10, the second driving part 620 is disposed to be parallel with the first driving part 610 on the same plane.

As described above, since the first and second driving parts 610 and 620 are horizontally disposed to be spaced part from each other, the spaced distance between the case 100 and the first holder 200 and between the case 100 and the second holder 300 are the same by the first and second driving parts 610 and 620, and thus it is possible to make better use of a space, thereby reducing an entire size thereof.

And the second driving part 620 is comprised of a second coil member 621, a second magnet 622 and a second magnetic member 623.

The second driving part 620 is the same as the first driving part 610 except that the second coil member 621 and the second magnetic member 623 are installed at the outer side surface of the second holder 300, and the second magnet 622 is installed at the inner side surface of the main body 110. Therefore, the detailed description thereof will be omitted.

If necessary, the second coil member 621 and the second magnetic member 623 may be installed at the inner side surface of the main body 110, and the second magnet 622 may be installed at the outer side surface of the second holder 300.

As described above, since the first driving part 610 is comprised of the first coil member 611 and the first magnet 612 and the second driving part 620 is comprised of the second coil member 621 and the first magnet 622, the first and second holders 200 and 300 can be respectively moved left and right by the electromagnetic induction law when power is applied, and thus it is possible to simplify the structure thereof.

Further, the first and second magnetic members 613 and 623 are respectively disposed to be opposed to the first and second magnets 612 and 622 so that the first and second holders 200 and 300 are attracted left and right by the influence of gravity of the first and second magnets 612 and 622. Therefore, when the first and second holders 200 and 300 are moved left and right by the first and second driving parts 610 and 620 and then returned to their initial positions, they can be moved with less force, thereby improving the driving efficiency and also preventing the first and second holders 200 and 300 from being undesirably moved left and right.

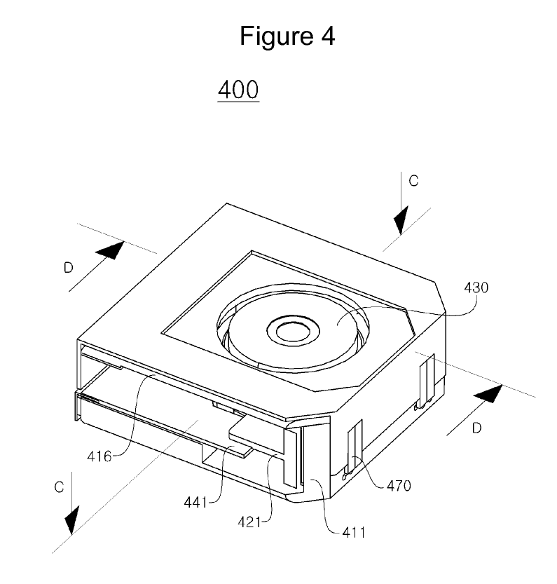

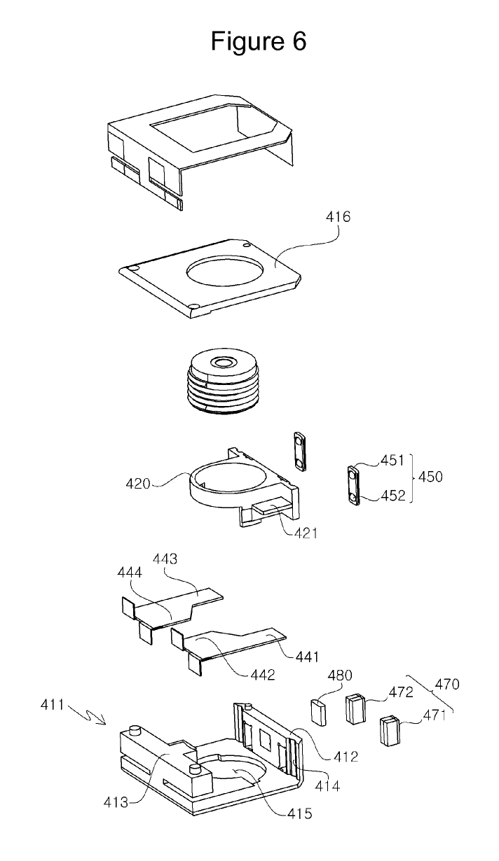

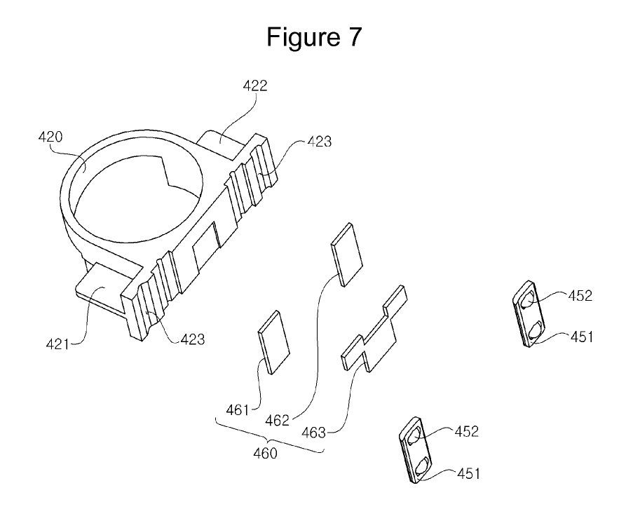

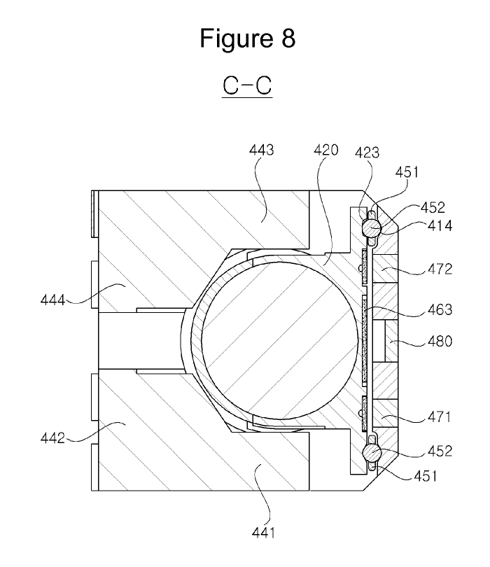

Meanwhile, as shown in FIGS. 4 to 9, the compact camera actuator 400 includes a housing 410, a lens holder 420, a driving means 440, a guiding means 450, a magnetic body 460 and a magnet 470.

The housing 410 formed into a hexahedral shape is comprised of a base 411 and a cover 416.

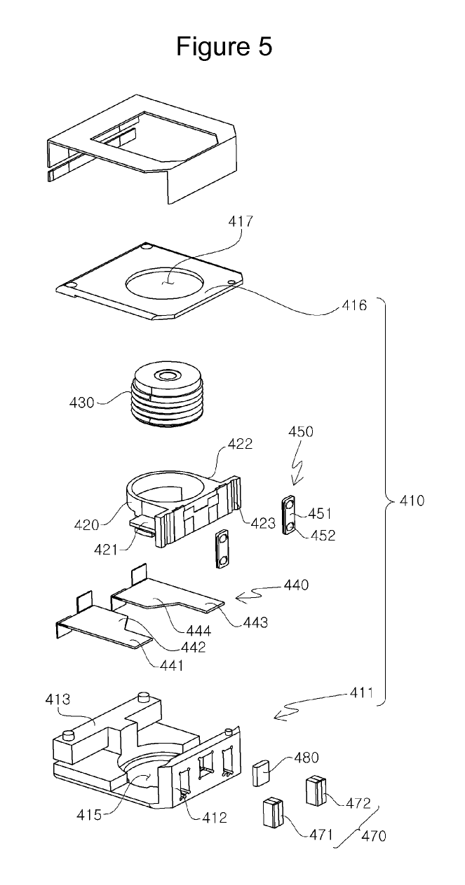

As shown in FIG. 5, the base 411 is formed into a square shape. A side part 412 is formed at one end of the base 411 and a mounting part 413 is formed at the other end thereof.

The side part 412 is formed into a square shape so as to be protruded upward, and the magnet 470 is installed therein, as described later.

Further, a first guide groove 414 is formed upward and downward in an inner side surface of the side part 412.

The first guide groove 414 is formed into a circular arc shape so as to be opened upward and downward or in a direction of the lens holder 420.

One end of a guide ball 452 of the guiding means 450 is inserted into the first guide groove 414, as described later.

The mounting part 413 is formed into a square shape so as to be protruded upward. The mounting part 413 is also formed with a groove which is formed left and right at a longitudinal (up and down) center portion thereof and in which the driving means 440 is inserted.

A first opening 415 formed into a circular shape is formed at a center portion of the base 411 so as to be penetrated up and down.

The cover 416 is formed into a square plate shape and fixed to an upper end of the base 411.

A second opening 417 is formed at a center portion of the cover 416 so as to be communicated with the first opening 415.

The lens holder 420 is installed in the housing 410 so as to be movable up and down.

The lens holder 420 is formed into a cylindrical shape of which a center portion is opened upward and downward so that a lens 430 can be installed therein.

The lens holder 420 is arranged so as to be concentric with the first and second openings 415 and 416.

Further, first and second supporting plates 421 and 422 are formed at an outer circumferential surface of the lens holder 420 so as to be protruded left and right, respectively.

The first and second supporting plates 421 and 422 are respectively formed into a wide square plate shape and arranged to have bilateral symmetry.

The first and second supporting plates 421 and 422 are respectively contacted with first and second polymer members 441 and 443 of the driving means 440 so as to transmit up/down driving force to the lens holder 420.

Further, a second guide groove 423 is formed upward and downward in a side surface of the lens holder 420.

The second guide groove 423 is formed into a circular arc shape so as to be opened upward and downward or in a direction of the first guide groove 414.

The other end of the guide ball 452 of the guiding means 450 is inserted into the second guide groove 423, as described later.

As described above, since the first and second guide grooves 414 and 423 are respectively formed in the base 411 and the lens holder 420 so that both ends of the guide ball 452 can be inserted therein, it is prevented that the guide ball 452 is moved left and right when the lens holder 420 is moved up and down, and thus it is prevented that the lens holder 420 is shaken left and right.

Meanwhile, the driving means 440 is installed in the housing 410 so as to move the lens holder 420 up and down when power is applied.

More detailedly, the driving means 440 includes the first and second polymer members 441 and 443.

The first polymer member 441 is formed into a square thin plate shape. One end of the first polymer member 441 is fixed to the mounting part 413 of the housing 410, and the other end thereof is contacted with a lower portion of the first supporting plate 421 so as to support the lens holder 420.

The other end of the first polymer member 441 is bent upward when power is applied to the first polymer member 441. Thus, upward force is transmitted to the lens holder 420 through the first supporting plate 421, thereby lifting up the lens holder 420.

The material and properties of the first polymer member 441 are described detailedly in U.S. Pat. No. 7,169,822, Japanese Patent Application Laid-Open No. 2006-172635 and Korean Patent Application Laid-Open No. 10-2010-0036548.

Further, a first holding part 442 is formed at one end of the first polymer member 441 so as to be protruded toward the lens holder 420 and thus to cover the outer circumferential surface of the lens holder 420.

The first holding part 442 is disposed so that a side surface thereof is contacted with the outer circumferential surface of the lens holder 420, and thus it is prevented that the lens holder 420 is shaken left and right.

The second polymer member 443 is formed to be symmetrical with the first polymer member 441 about the lens holder 420. One end of the second polymer member 443 is fixed to the mounting part 413 of the housing 410, and the other end thereof is contacted with a lower portion of the second supporting plate 422 so as to support the lens holder 420.

And a second holding part 444 is formed at one end of the second polymer member 443 so as to be protruded toward the lens holder 420.

The second holding part 444 is formed to be symmetrical with the first holding part 442 about the lens holder 420.

The second holding part 444 is disposed to be contacted with the outer side surface of the lens holder 420, thereby preventing the lens holder 420 from be moved left and right.

Like the first polymer member 441, when power is applied to the second polymer member 443, the second polymer member 443 is bent upward so as to lift up the lens holder 420 through the second supporting plate 422.

As described above, since each end of the first and second polymer members 441 and 443 is bent upward when power is applied, so that the lens holder 420 is lifted up, it is possible to drive the lens holder 420 with a simple structure, thereby reducing the entire size and also facilitating a design thereof.

Further, the first and second holding parts 442 and 444 are protruded toward the lens holder 420 so as to cover the outer circumferential surface of the lens holder 420, such that the side surfaces of the first and second holding parts 442 and 444 are disposed to be adjacent to the outer circumferential surface of the lens holder 420, thereby preventing the lens holder 420 from being shaken left and right.

Meanwhile, the guide means 450 is disposed between the lens holder 420 and the housing 410 so as to guide the lens holder 420 upward and downward.

More detailedly, the guide means 450 is comprised of the guide plate 451 and the guide ball 452.

The guide plate 451 is formed into an elongated flat rectangular shape.

The guide plate 451 is disposed between the side part 412 of the base 411 and an side surface of the lens holder 420 so as to be spaced apart from the base 411 and the lens holder 420.

The guide ball 452 is rotatably inserted into the guide plate 451.

The guide ball 452 is formed into a sphere shape. A diameter of the guide ball 352 is larger than a thickness of the guide plate 451 and thus both ends of the guide ball 452 are protruded in one direction and the other direction of the guide plate 451.

An outer circumferential surface of a center portion of the guide ball 452 is covered by the guide plate 451 so as to be not easily separated from the guide plate 451.

Further, one end of the guide ball 452 is inserted into the first guide groove 414 of the side part 412 so as to be contacted with the side part 412, and the other end thereof is inserted into the second guide groove 423 of the lens holder 420 so as to be contacted with a side surface of the lens holder 420.

When the lens holder 420 is moved up and down, the guide ball 452 is rotated upward and downward by friction between the lens holder 420 and the side part 412.

As described above, since the guide ball 452 is contacted with the side surface of the lens holder 420 and the side surface of the housing 410 so as to be rotated when the lens holder 420 is moved up and down, it is possible to reduce the friction with the guide ball 452, the lens holder 420 and the housing 410 when the lens holder 420 is lifted up and thus to reduce resistant force applied to the lens holder 420, thereby allowing the lens holder 420 to be driven with small force, reducing its components and also simplifying its structure.

Meanwhile, the magnetic body 460 is fixed to a side surface of the lens holder 420 so that force is applied downward to the lens holder 420.

More detailedly, the magnetic body 460 is comprised of a first iron piece 461, a second iron piece 462 and a third iron piece 463.

The first and second iron pieces 461 and 462 are formed into a flat rectangular plate shape which is elongated up and down and also has a property of sticking to the magnet.

And the first and second iron pieces 461 and 462 are disposed at left and right side surfaces of the lens holder 420 so as to be spaced apart from each other.

The first and second iron pieces 461 and 462 function to move the lens holder 420 downward by using the influence of gravity of the magnet 470, as described later.

The third iron piece 463 is formed into a flat square shape, fixed to a side surface of the lens holder 420 and has a property of sticking to the magnet.

And the third iron piece 463 is disposed between the first and second iron pieces 461 and 462.

The magnet 470 is formed into a square shape, disposed to be oppositely spaced apart from the magnetic body 460 and fixed to the side part 412.

The magnet 470 is comprised of a first magnet 471 and a second magnet 472.

The first magnet 471 is disposed to be oppositely spaced apart from the first iron piece 461 and fixed to the side part 412 of the housing 410.

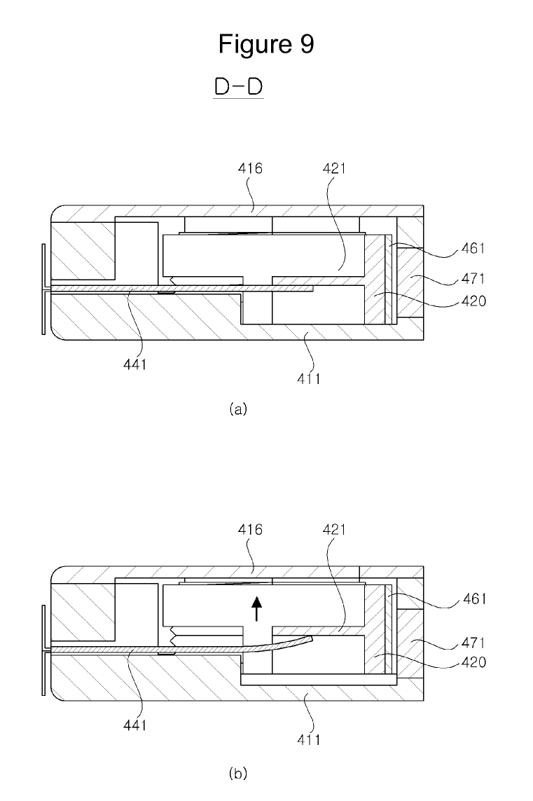

As shown in FIG. 9, a longitudinal (up and down) center portion of the first magnet 471 is disposed to be lower than a longitudinal (up and down) center portion of the first iron piece 461.

The second magnet 472 is disposed to be oppositely spaced apart from the second iron piece 462 and fixed to the side part 412 of the housing 410.

And as shown in FIG. 9, a longitudinal (up and down) center portion of the second magnet 472 is disposed to be lower than a longitudinal (up and down) center portion of the second iron piece 462.

As described above, since the longitudinal (up and down) center portions of the first and second magnets 471 and 472 are disposed to be lower than the longitudinal (up and down) center portions of the first and second iron pieces 461 and 462, the first and second magnets 471 and 472 attracts downward the first and second iron pieces 461 and 462 so that the lens holder 420 can be returned to its initial position. And also it is possible to prevent the lens holder 420 from being undesirably moved up and down by external force.

Further, the first and second magnets 471 and 472 are disposed to be symmetric with respect to the third iron piece 463.

As described above, since the first and second magnets 471 and 472 are disposed to be symmetric with respect to the third iron piece 463, the force of gravity generated between the third iron piece 463 and the first and second magnets 471 and 472 is uniformly applied to left and right sides of the third iron piece 463, and thus it is possible to prevent the lens holder 420 from being shaken left and right.

Meanwhile, if necessary, the compact camera actuator 400 may a VCM actuator proposed by the applicant.

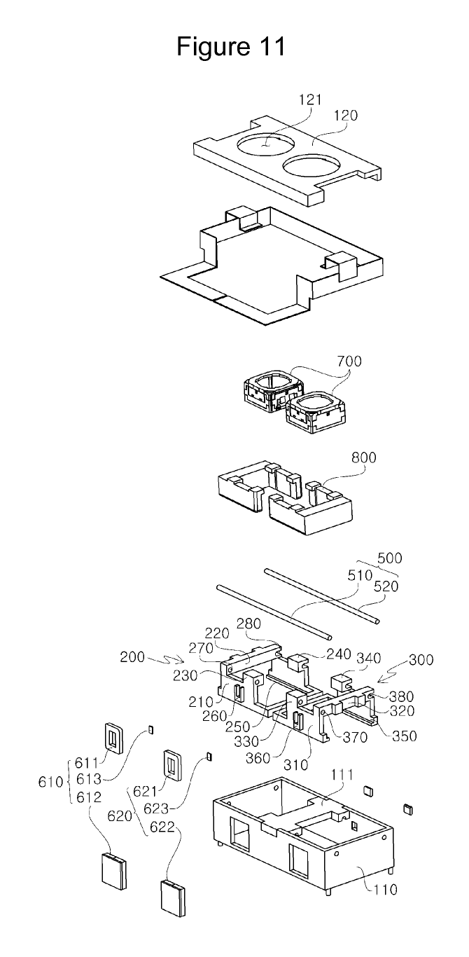

FIG. 11 is an exploded perspective view of the compact stereoscopic image photographing device according to other type of the first embodiment of the present invention.

The VCM actuator is described fully in Korean Patent Application No. 10-2009-0046731 filed by the applicant, and thus the detailed description thereof will be omitted.

Further, as shown in FIG. 11, since the VCM actuator 700 is smaller than the actuator 400 of the present invention, a spacer 800 is disposed among the first and second holders 200 and 300 and the actuator 700.

The spacer 700 is formed into a square shape and also formed to cover the actuator 700. An upper end of the spacer 700 is protruded upward so as to prevent the actuator 700 from being separated from the spacer 700.

Hereinafter, the operation of the compact camera actuator 400 according to the embodiment of the present invention will be described.

FIG. 9a shows a state before the lens holder 420 is lifted up, and FIG. 9b shows a state that the lens holder 420 is lifted up.

As shown in FIG. 9a, when power is not applied to the first polymer member 441, the first polymer member 441 and the first supporting plate 421 are arranged to be parallel with each other.

And the longitudinal (up and down) center portion of the first iron piece 461 is located to be higher than the longitudinal (up and down) center portion of the first magnet 471, and thus downwardly attracting force is applied to the lens holder 420 due to the influence of gravity between the first iron piece 461 and the first magnet 471. Therefore, it is prevented that the lens holder 420 is readily moved up and down by external force.

If necessary, when power is not applied to the first polymer member 441, the longitudinal (up and down) center portion of the first iron piece 461 may be located to be lower than the longitudinal (up and down) center portion of the first magnet 471. In this case, the downwardly attracting force is not applied to the lens holder 420 and thus the lens holder 420 cannot be moved up and down. Therefore, it is preferable that the longitudinal (up and down) center portion of the first iron piece 461 is located to be higher than the longitudinal (up and down) center portion of the first magnet 471.

Then, as shown in FIG. 9b, if power is applied to the first and second polymer members 441 and 443 in order to adjust the focus of an object, the other ends of the first and second polymer members 441 and 443 are bent upward, and thus the lens holder 420 is lifted up together with the first and second supporting plates 421 and 422.

Herein, the longitudinal (up and down) center portion of the first iron piece 461 is located to be higher than the longitudinal (up and down) center portion of the first magnet 471, downwardly attracting force is applied to the lens holder 420 due to the force of gravity between the first iron piece 461 and the first magnet 471.

When the lens holder 420 is lifted up, the guide ball 452 is rotated clockwise so as to reduce the friction between the lens holder 420 and housing 410.

Then, when the lens holder is lifted down, power supplied to the first and second polymer members 441 and 442 is shut off.

Therefore, the lens holder 420 is moved down due to the influence of gravity among the first and second iron pieces 461 and 462 and the first and second magnets 471 and 472.

As described above, since the magnetic body 460 and the magnet 470 which are respectively installed at the lens holder 420 and the housing 410 are disposed to be oppositely spaced apart from each other, the lens holder 420 is attracted downward by the influence of gravity between the magnetic body 460 and the magnet 470 and thus returned to its initial position without a separate spring. When the lens holder 420 is lifted up, the force which is applied downward to the lens holder 420 is less than force of a conventional flat spring, and thus the lens holder 420 can be lifted up with small force.

Further, since the force necessary to lift up the lens holder 420 is reduced, the lens holder 420 can be lifted up through the first and second polymer members 441 and 442. Therefore, it is possible to reduce an amount of the polymer member and thus it is possible to simplify the entire structure of the actuator.

FIG. 10a shows an initial state before the first and second holders 200 and 300 are driven, and FIG. 10b shows a state that first and second holders 200 and 300 are moved.

As shown in FIG. 10a, when power is not applied to the first and second coil members 611 and 621, the first holder 200 is arranged at the left side of the main body 110 by the influence of gravity between the first magnetic member 613 and the first magnet 612, and the second holder 300 is arranged at the right side of the main body 110 by the influence of gravity between the second magnetic member 623 and the second magnet 622.

Then, as shown in FIG. 10b, when power is supplied to the first and second coil members 611 and 621 in order to adjust a vergence angle of the lens 430 installed in the compact camera actuator 400, the first holder 200 is moved right along the guide shaft 500, and the second holder 300 is moved left along the guide shaft 500.

And in order to move the first holder 200 or the second holder 300 to a position that they are opposed to each other, the power supplied to the first and second coil members 611 and 621 is shut off.

Then, the first and second holders 200 and 300 are automatically moved left and right by the influence of gravity among the first and second coil members 611 and 621 and the first and second magnets 612 and 622.

Of course, as the case may be, i.e., if the force necessary to move the first holder 200 left is weak, a direction of current flowing through the first and second coil members 611 and 621 is switched to an opposite direction so that the first and second holders 200 and 300 can be moved left and right.

It is possible to obtain a 3D image by adjusting a space between the first and second holders 200 and 300 having the compact camera actuator 400, adjusting the vergence angle of an object picked up on an image sensor and using the image picked up on the image sensor.

Hereinafter, a second embodiment of the present invention will be described.

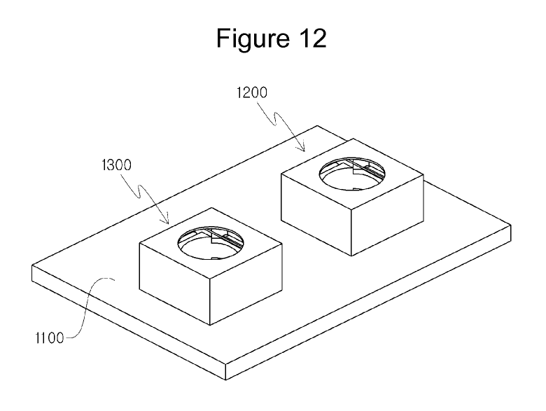

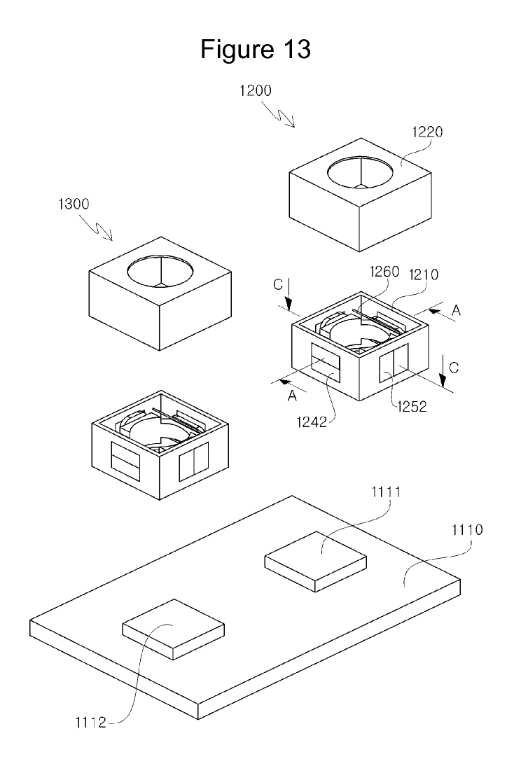

As shown in FIGS. 12 to 17, a compact stereoscopic image photographing device according to the second embodiment of the present invention includes a base 1110, a first image sensor 1111, a second image sensor 1112, a first lens (not shown), a second lens (not shown), a first actuator 1200 and a second actuator 1300.

The base 1110 includes a circuit board on which the first and second image sensors 1111 and 1112 are mounted.

Further, although not shown in the drawings, a main CPU is mounted on the base 1110 so as to operate the first and second actuators 1200 and 1300 on the basis of image information picked up on the first and second image sensors 1111 and 1112.

The first and second image sensors 1111 and 1112 are formed into a square shape and disposed to be spaced left and right from each other.

The first and second image sensors 1111 and 1112 function to convert an image of an object picked up through the first and second lenses into an electric image signal.

The first and second actuators 1200 and 1300 are respectively disposed at upper sides of the first and second image sensors 1111 and 1112.

The first actuator 1200 is mounted on the base 1110 so as to be arranged at an upper side of the first image sensor 1111. The first lens is installed in the first actuator 1200 so as to be moved up/down and left/right.

More detailedly, the first actuator 1200 includes a holder 1210, a cover 1220, a lens unit 1230, a first driving part 140, a second driving part 1250 and a wire spring 1260.

The holder 1210 is formed into a hexahedral shape of which upper and lower portions are opened and each side portion is formed with an installing hole 1211.

The installing hole 1211 is formed into a square shape and formed to pass through the side portion of holder 1210. A first magnet 1242 of the first driving part 1240 and a second magnet 1252 of the second driving part 1250 are inserted into the each installing hole 1211, as described later.

The lens unit 1230 is installed in the holder 1210 so as to be moved up/down and left/right.

The cover 1220 is formed into a hexahedral shape of which upper and lower portions are opened. The cover 1220 is disposed to cover upper and side portions of the holder 1210, thereby protecting the inside of the holder 1210.

Further, the cover 1220 is formed of a magnetic material and disposed to cover the first and second magnets 1242 and 1252.

And the cover 1220 induces magnetic force lines generated from N-poles of the first and second magnets 1242 and 1252 to S-poles of the first and second magnets 1242 and 1252 through the first and second coil members 1242 and 1252.

Also, the cover 1220 prevents loss of the magnetic force lines generated from the first and second magnets 1242 and 1252, thereby enhancing the efficiency of a magnetic circuit.

Further, since the cover 1220 performs the function of a yoke and the function of protecting the holder 1210 at the same time, it is possible to simplify the entire structure thereof.

The lens unit 1230 is formed into a hexahedral shape, and a circular opened hole 1231 is formed at a center portion of the lens unit 1230.

The opened hole 1231 is formed to pass through the lens unit 1230 upward and downward, and the first lens is provided in the opened hole 1231. A center of the opened hole 1231 is concentric with an optical axis of the first lens.

Further, a first protrusion 1232 is formed at one side portions of the lens unit 1230 so as to be protruded toward the holder 1210, i.e., toward the first magnet 1242 of the first driving part 1240, as described later.

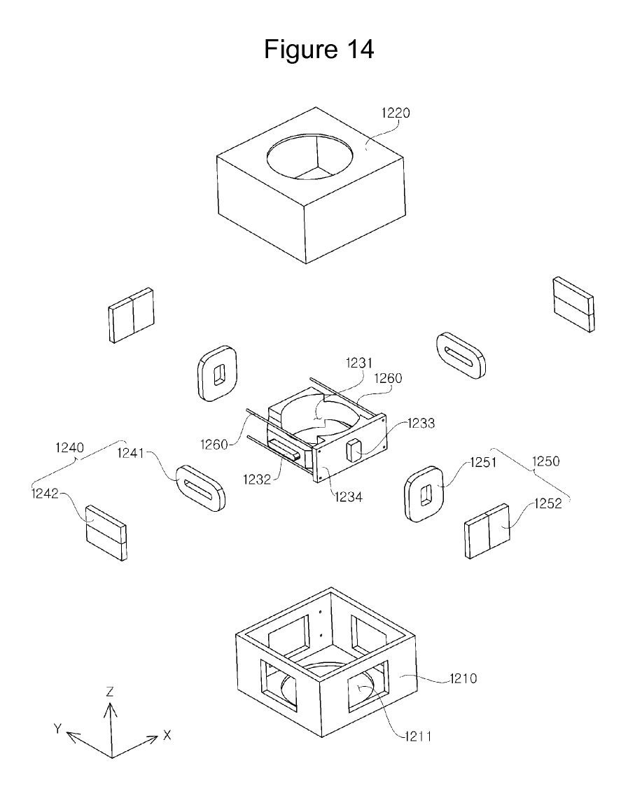

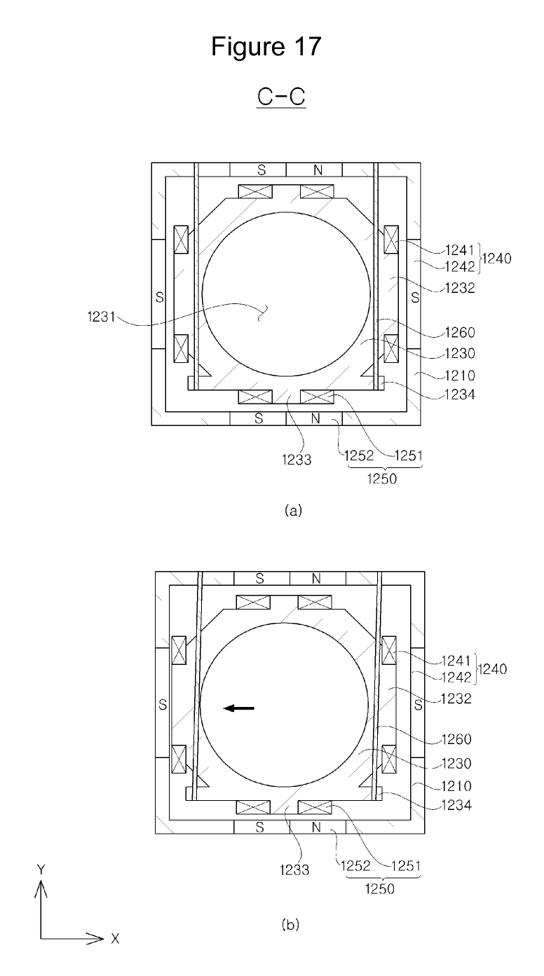

As shown in FIGS. 14 and 17, the one side portions of the lens unit 1230 mean X-axial both sides, i.e., left and right sides of the lens unit 1230.

The first protrusion 1232 is formed into square shape in which a Y-axial width is larger than a Z-axial width. The first protrusion 1232 is protruded from the left and right sides of the lens unit 1230 so as to have bilateral symmetry.

Further, a second protrusion 1233 is formed at the other side portions of the 1230 so as to be protruded toward the holder 1210, i.e., toward the second magnet 1252, as described later.

As shown in FIGS. 14 and 17, the other side portions of the lens unit 1230 mean Y-axial both sides, i.e., front and rear sides of the lens unit 1230.

The second protrusion 1233 is formed into square shape in which a Z-axial width is larger than an X-axial width.

The second protrusion 1233 is protruded from the front and rear sides of the lens unit 1230 so as to be symmetric with respect to the opened hole 1231.

Further, as described later, a connection part 1234 in which the wire spring 1260 is installed is formed at the front side of the lens unit 1230.

The connection part 1234 is formed into a square shape and also formed to be protruded left and right.

Meanwhile, the first driving part 1240 is disposed between one side portion of the holder 1210 and one side portion of the lens unit 1230 so as to move the lens unit 1230 up and down.

More detailedly, the first driving part 1240 is comprised of a first coil member 1241 and a first magnet 1242.

The first coil member 1241 is a wire through which current is flowed. The first coil member 1241 is wound around the first protrusion 1232 and installed at the one side portion of the lens unit 1230.

That is, two first coil members 1241 are installed at left and right sides of the lens unit 1230.

Further, as shown in FIG. 14, the first coil member 1241 is formed so that a Y-axial width thereof is larger than a Z-axial width.

The first magnet 1242 is disposed to be opposed to the first magnet 1242 and installed at one side portions of the holder 1210.

The one side portions of the holder 1210 mean left and right sides thereof, and two first magnets 1242 are fixedly inserted in to the installing hole 1211 formed in the left and right sides of the holder 1210.

Further, the poles of the first magnet 1242 are divided upward and downward.

That is, as shown in FIGS. 14 and 17, the poles of the first magnet 1242 are divided in the Z-axial direction. In the embodiment, its lower end is the N-pole and its upper end is the S-pole.

Of course, if necessary, the lower end of the first magnet 1242 may be the S-pole and the upper end thereof may be the N-pole.

A first magnetic field is generated at the first magnet 1242, and the lens unit 1230 is move up and down by reciprocal action between the first magnetic field and a first electromagnetic field generated when power is applied to the first coil member 1241.

Further, if necessary, the first coil member 1241 may be installed at the holder 1210, and the first magnet 1242 may be installed at the lens unit 1230. However, in this case, a weight load applied to the lens unit 1230 is increased by the first magnet 1242 heavier than the first coil member 1241, and thus power consumption may be increased.

Therefore, like in the embodiment of the present invention, it is preferable that the first coil member 1241 is installed at the lens unit 1230 and the first magnet 1242 is installed at the holder 1210. Thus, when the lens unit 1230 is moved, the weight loaded to the lens unit 1230 is reduced, thereby reducing the power consumption of the first coil member 1241.

The second driving part 1250 is disposed between the other side portion of the holder 1210 and the other side portion of the lens unit 1230 so as to move the lens unit 1230 left and right.

More detailedly, the second driving part 1250 is comprised of a second coil member 1251 and a second magnet 1252.

The second coil member 1251 is a wire through which current is flowed. The second coil member 1251 is wound around the second protrusion 1233 and installed at the other side portion of the lens unit 1230.

That is, two second coil members 1251 are installed at front and rear sides of the lens unit 1230.

Further, as shown in FIG. 14, the second coil member 1251 is formed so that a Z-axial width thereof is larger than an X-axial width.

The second magnet 1252 is disposed to be opposed to the second magnet 1251 and installed at the other side portions of the holder 1210.

As shown in FIG. 14, the other side portions of the holder 1210 mean Y-axial both sides of the holder 120, which are adjacent to the other side portions of the holder 1210, i.e., front and rear sides thereof.

Two second magnets 1252 are fixedly inserted in to the installing hole 1211 formed in the front and rear sides of the holder 1210.

Further, the poles of the second magnet 1252 are divided left and right.

That is, as shown in FIGS. 14 and 17, the poles of the second magnet 1252 are divided in the X-axial direction. In the embodiment, its left side is the S-pole and its right side is the N-pole.

Of course, if necessary, the right side of the second magnet 1252 may be the S-pole and the left side thereof may be the N-pole.

A second magnetic field is generated at the second magnet 1252, and the lens unit 1230 is move left and right by reciprocal action between the second electromagnetic field and a second electromagnetic field generated when power is applied to the second coil member 1251.

Further, if necessary, the second coil member 1251 may be installed at the holder 1210, and the second magnet 1252 may be installed at the lens unit 1230. However, in this case, a weight load applied to the lens unit 1230 is increased by the second magnet 1252 heavier than the second coil member 1251, and thus power consumption may be increased.

Therefore, like in the embodiment of the present invention, it is preferable that the second coil member 1251 is installed at the lens unit 1230 and the second magnet 1252 is installed at the holder 1210. Thus, when the lens unit 1230 is moved, the weight loaded to the lens unit 1230 is reduced, thereby reducing the power consumption of the second coil member 1251.

As described above, the second driving part 1250 is disposed between the other side portion of the holder 1210 and the other side portion of the lens unit 1230 so as to move the lens unit 1230 left and right. Therefore, the second driving part 1250 moves left and right the lens unit 1230 independently from the first driving part 1240, and thus it is possible to reduce the weight thereof when the lens unit 1230 is moved left and right and also it is possible to reduce the number of components and simplify the entire structure of the photographing device.

Further, the second driving part 1250 moves the first lens left and right and adjusts a vergence angle of an image picked up on the first and second image sensors by also using the second lens which is moved left and right by the second actuator 1300.

Meanwhile, the wire spring 1260 is formed of a thin elastic wire. The wire spring 1260 connects the other side portion of the lens unit 1230 and the other side portion of the holder 1210 and thus elastically supports the lens unit 1230 left/right and up/down.

More detailedly, one end of the wire spring 1260 is installed at the connection part 1234, and the other end thereof is installed at the other side portion of the holder 1210, which is opposed to the connection part 1234, i.e., the rear side of the holder 1210.

When the lens unit 1230 is moved up/down and left/right, the wire spring 1260 is bent upward/downward and left/right with the fixed other end of the holder 1210 as a turning point, thereby supporting the lens unit 1230.

As described above, since the wire spring 1260 connects the other side portion of the lens unit 1230 and the other side portion of the holder 1210 so as to elastically support the lens unit 1230 up/down and left/right, it is possible to completely support the lens unit 1230 without separate springs, thereby reducing the number of the wire springs 1260, reducing the load applied to the lens unit 1230 when the lens unit 1230 is moved and also simplifying the entire structure of the photographing device.

Meanwhile, the second actuator 1300 is mounted on the base 1110 so as to be arranged at an upper side of the first image sensor 1111. As shown in FIG. 12, the second actuator 1300 is disposed at the right side of the first actuator 1200.

The second actuator 1300 is provided with the second lens. The second actuator 1300 is the same as the first actuator 1200 except to move the second lens up/down and left/right, and thus the detailed description thereof will be omitted.

Hereinafter, the operation of the compact stereoscopic image photographing device according to the embodiment of the present invention will be described.

First of all, the operation of the first actuator 1200 will be described.

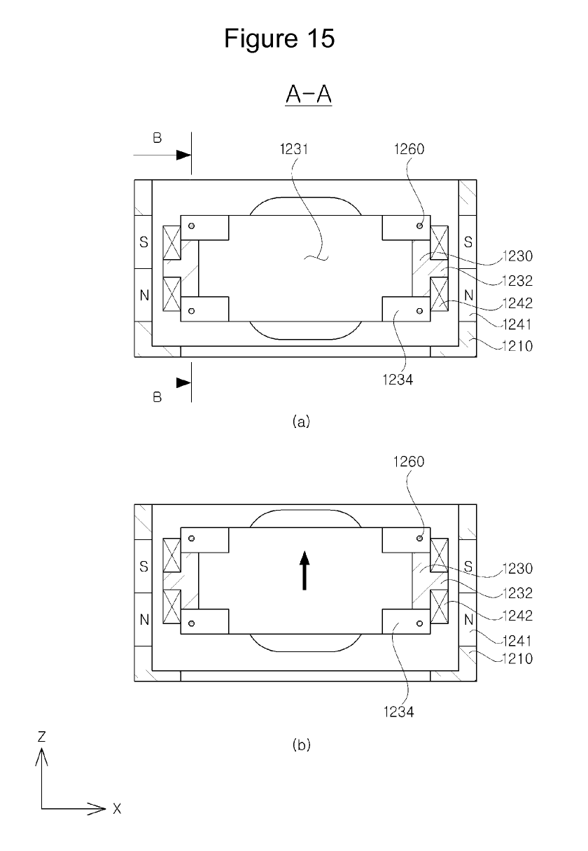

FIGS. 15(1a), 16(1a) and 17(1a) show an initial state of the lens unit 1230.

In the initial state, power is not supplied to the first and second coil members 1241 and 1251. As shown in FIG. 4(1a), a center portion of the first coil member 1241 is arranged to be adjacent to a center portion of the first magnet 1242.

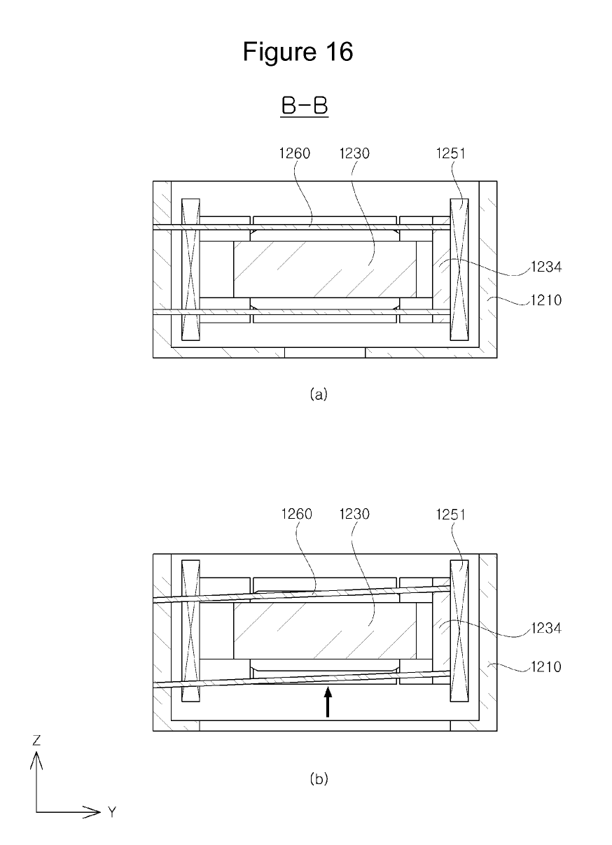

And as shown in FIG. 16(1a), the wire spring 1260 is arranged to be parallel with the lens unit 1230.

Further, as shown in FIG. 17(1a), the second magnet 1252 and the second coil member 1251 are symmetric with respect to lens unit 1230.

First, the up and down movement of the lens unit 1230 through the first driving part 1240 will be described.

As shown in FIG. 15(1b), when power is applied to the first coil member 1241, the lens unit 1230 is lifted up by the reciprocal action between the first electromagnetic field generated from the first coil member 1241 and the first magnetic field generated from the first magnet 1242.

If the lens unit 1230 is lifted up, one end of the wire spring 1260 fixed to the connection part 1234 is also lifted up together with the lens unit 1230 and thus bent and relaxed.

Herein, the wire spring 1260 elastically supports the lens unit 1230 toward its initial position, i.e., downward by its own elastic force. If the power supplied to the first coil member 1241 is shut off, the wire spring 1260 moves the lens unit 1230 toward the initial position, i.e., downward.

Of course, if a direction of current applied to the first coil member 1241 is reversed, the lens unit 1230 is lifted down.

By this process, the first driving part 1240 moves lens unit 1230 up and down and automatic focusing with respect to an object is achieved.

That is, the first driving part 1240 moves the lens unit 1230 up and down so as to achieve the automatic focusing with respect to the object picked up on the first image sensor 1111.

Secondly, the left and right movement of the lens unit 1230 through the second driving part 1250 will be described.

As shown in FIG. 17(1b), if power is supplied to the second coil member 1251, the lens unit 1230 is moved left by the reciprocal action between the second electromagnetic field generated from the second coil member 1251 and the second magnetic field generated from the second magnet 1252.

Herein, one end of the wire spring 1260 fixed to the connection part 1234 is also moved left together with the lens unit 1230 and thus bent.

Herein, the wire spring 1260 elastically supports the lens unit 1230 toward its initial position, i.e., right by its own elastic force. If the power supplied to the second coil member 1251 is shut off, the wire spring 1260 moves the lens unit 1230 toward the initial position, i.e., right.

Of course, if a direction of current applied to the second coil member 1251 is reversed, the lens unit 1230 is moved right.

Meanwhile, the operation of the second actuator 1300 is the same as that of the first actuator 1200, and thus the detailed description thereof will be omitted.

By above-mentioned processes, the first and second actuators 1200 and 1300 adjust a space between the first and second lenses and thus adjust the vergence angle with respect to an object picked up on the first and second image sensors 1111 and 1112 through the first and second lenses.

As described above, the first and second actuators 1200 and 1300 adjust the vergence angle with respect to the object picked up on the first and second image sensors 1111 and 1112, thereby obtaining a 3D image using the images picked up on the image sensors.

### INDUSTRIAL APPLICABILITY

As described above, the present invention can be applied to a camera in a mobile phone or the like so as to adjust the vergence of the two lenses angle with respect to the object, thereby taking the 3D image.

While the present invention has been described with respect to the specific embodiments, it will be apparent to those skilled in the art that various changes and modifications may be made without departing from the spirit and scope of the invention as defined in the following claims.

1. A compact stereoscopic image photographing device, comprising:
a case;
a first holder and a second holder which are mounted to be spaced apart from each other on the left and right sides in the case so that the holders can be moved left and right, each of the holders having a compact camera actuator therein;
a guide shaft which passes through the first and second holders and which is mounted on the case so as to guide left and right movements of the first holder and the second holder; and
left and right driving parts which are mounted respectively on the first holder and the second holder so as to move the first holder and the second holder left and right.

2. The compact stereoscopic image photographing device according to claim 1, wherein the guide shaft comprises a firs guide shaft and a second guide shaft which are parallelly disposed to be spaced apart from each other, and
one end of the first holder and one end of the second holder are formed with a first insertion hole which is opened left and right, and the other end of the first holder and the other end of the second holder are formed with a second insertion hole which is opened left and right in an opposite direction of the first insertion hole.

3. The compact stereoscopic image photographing device according to claim 1, wherein the left and right driving parts comprise a first driving part which is disposed between an outer side surface of the first holder and an inner side surface of the case; and a second driving part which is disposed between an outer side surface of the second holder and an inner side surface of the case so as to be horizontally spaced apart from the first driving part.

4. The compact stereoscopic image photographing device according to claim 3, wherein the first driving part comprises a first coil member which is installed at one of a side surface of the first holder and a side surface of the case; and a first magnet which is installed at one of a side surface of the first holder and a side surface of the case so as to be oppositely spaced apart from the first coil member, and
the second driving part comprises a second coil member which is installed at one of a side surface of the second holder and a side surface of the case; and a second magnet which is installed at one of a side surface of the second holder and a side surface of the case so as to be oppositely spaced apart from the second coil member.

5. The compact stereoscopic image photographing device according to claim 4, wherein the first driving part further comprises a first magnetic member installed at one of the side surface of the first holder and the side surface of the case, in which the first coil member is installed, and
the second driving part further comprises a second magnetic member installed at one of the side surface of the first holder and the side surface of the case, in which the second coil member is installed, and
wherein the first magnetic member and the second magnetic member are oppositely spaced apart from the first magnet and the second magnet, respectively, so as to attract the first holder and the second holder in left and right directions by influence of gravity with the first magnet and the second magnet when the first holder and the second holder are moved.

6. The compact stereoscopic image photographing device according to claim 1, wherein the first holder and the second holder comprise a body part which covers one end and the other end of the compact camera actuator; a first supporting part which connects an upper portion of one end of the body part and an upper portion of the other end thereof so as to cover one side of an upper surface of the compact camera actuator and through which the guide shaft is passed; a second supporting part and a third supporting part which are respectively protruded in opposite directions to each other at upper portions of the one end and the other end of the body part so as to be contacted with the other end of the upper surface of the compact camera actuator and which are spaced apart in a left or right direction of the first supporting part and also through which the guide shaft is passed; and a fourth supporting part which is protruded from a lower portion of the body part to a lower portion of the compact camera actuator so as to support the lower portion of the compact camera actuator.

7. A compact camera actuator comprising:
a housing;
a lens holder which is movably installed in the housing and in which a lens is provided;
a driving means which is installed at the housing so as to move the lens holder upward when power is applied;
a magnetic body which is fixed to one of the lens holder and the housing; and
a magnet which is fixed to the other of the lens holder and the housing,
wherein the magnet body and the magnet are spaced apart from each other, and downwardly attracting force is applied to the lens holder by influence of gravity between the magnetic body and the magnet.

8. The compact camera actuator according to claim 7, wherein a first supporting plate and a second supporting plate are protruded from left and right sides of the lens holder, and the driving means comprises a first polymer member of which one end is fixed to the housing and the other end is contacted with a lower portion of the first supporting plate so as to support the first supporting plate; and a second polymer member of which one end is fixed to the housing and the other end is contacted with a lower portion of the second supporting plate so as to support the second supporting plate, and the other end of the first polymer member and the other end of the second polymer member are bent upward so as to lift up the lens holder when power is applied to the first polymer member and the second polymer member.

9. The compact camera actuator according to claim 8, wherein one end of the first polymer member and one end of the second polymer member are respectively formed with a first holding part and a second holding part which are protruded toward the lens holder so as to cover an outer circumferential surface of the lens holder.

10. The compact camera actuator according to claim 7, wherein the magnetic body is installed at the lens holder, and the magnet is installed at the housing, and the magnetic body comprises a first iron piece and a second iron piece which are disposed at side surfaces of the lens holder so as to be spaced apart in left and right directions; and a third iron piece which is disposed between the first iron piece and the second iron piece so as to be installed at a side surface of the lens holder, and the magnet comprises a first magnet which is fixed to a side surface of the housing so as to be oppositely spaced apart from the first iron piece; and a second magnet which is fixed to a side surface of the housing so as to be oppositely spaced apart from the second iron piece, and the first magnet and the second magnet are symmetric with respect to the third iron piece.

11. The compact camera actuator according to claim 10, wherein, when the lens holder is lifted up by the driving means, a longitudinal center portion of the first iron piece is disposed to be higher than a longitudinal center portion of the first magnet, and a longitudinal center portion of the second iron piece is disposed to be higher than a longitudinal center portion of the second magnet.

12. The compact camera actuator according to claim 7, further comprising a guide means which is disposed between the lens holder and the housing so as to guide the lens holder upward.

13. The compact camera actuator according to claim 12, wherein the guide means comprises a guide plate which is movably disposed between a side surface of the lens holder and a side surface of the housing; and a guide ball which is rotatably inserted into the guide plate and contacted with the side surface of the lens holder and the side surface of the housing so as to be rotated upward and downward when the lens holder is moved up and down.

14. The compact camera actuator according to claim 13, wherein the side surface of the housing is formed with a first guide groove which is opened upward and downward so as to guide up and down movement of the guide ball, and
the side surface of the lens holder is formed with a second guide groove which is opened upward and downward so as to guide up and down movement of the guide ball.

15. A compact stereoscopic image photographing device, comprising:
a base having a first image sensor and a second image sensor which is spaced apart from each other; and
a first actuator having a first lens which picks up an object on the first image sensor;
a second actuator having a second lens which picks up the object on the second image sensor,
wherein the first actuator and the second actuator comprise a holder which is disposed at an upper side of the first image sensor or the second image sensor so as to be coupled to the base; a cover which covers the holder; a lens unit which is installed in the holder so as to be moved up/down and left/right and also has one of the first lens or the second lens therein; a first driving part which is disposed between one side portion of the holder and one side portion of the lens unit so as to move the lens unit up and down and thus to achieve automatic focusing of the object picked up on the first image sensor and the second image sensor through the first lens and the second lens; a second driving part which is disposed between the other side portion of the holder and the other side portion of the lens unit so as to move the lens unit left and right, and
a vergence angle with respect to the object picked up on the first image sensor and the second image sensor through the first lens and the second lens is adjusted by controlling a space between the first lens and the second lens using the second driving part.

16. The compact stereoscopic image photographing device according to claim 15, wherein the first driving part comprises a first coil member which is installed at one of one side surface of the holder and one side surface of the lens unit; and a first magnet which is installed at the other of one side surface of the holder and one side surface of the lens unit so as to be opposed to the first coil member, and
the second driving part comprises a second coil member which is installed at one of the other side surface of the holder and the other side surface of the lens unit; and a second magnet which is installed at the other of the other side surface of the holder and the other side surface of the lens unit so as to be opposed to the second coil member, and
the lens unit is moved up and down by reciprocal action between a first electromagnetic field generated when power is applied to the first coil member and a first magnetic field generated from the first magnet, and
the lens unit is moved left and right by reciprocal action between a second electromagnetic field generated when power is applied to the second coil member and a second magnetic field generated from the second magnet.

17. The compact stereoscopic image photographing device according to claim 16, wherein the first coil member is installed at one side portion of the lens unit, and the first magnet is installed at one side of the holder so as to be opposed to the first coil member, and
the second coil member is installed at the other side portion of the lens unit, and the second magnet is installed at the other side portion of the holder so as to be opposed to the second coil member, and
a first protrusion is formed at the one side portion of the lens unit to be protruded toward the first magnet, and a second protrusion is formed at the other side portion of the lens unit to be protruded toward the second magnet, and
the first coil member is wound around the first protrusion, and the second coil member is wound around the second protrusion, and
poles of the first magnet are divided up and down, and poles of the second magnet are divided left and right.

18. The compact stereoscopic image photographing device according to claim 15, further comprising a wire spring which connects the other side portion of the lens unit and the other side portion of the holder so as to elastically support the lens unit in all directions.

19. The compact stereoscopic image photographing device according to claim 16, wherein the cover is formed of a magnetic body and disposed to cover the first magnet and the second magnet so that magnetic force lines generated from N-poles of the first and second magnets are induced to S-pole of the first and second magnets through the first and second coil members.
